(19) United States
(12) Patent Application Publication
(10) Pub. No.: US 2006/0253773 A1
(43) Pub. Date: Nov. 9, 2006

(54) Web-based client/server interaction method and system

(76) Inventor: Cheng Han Hsieh, Taipei (TW)

Correspondence Address: Cheng Han Hsieh, No.9-1 2nd Floor, Hsing-Yi rd, Pei-Tou, Taipei, TW

(21) Appl. No.: 10/908,335

(22) Filed: May 9, 2005

(51) Int. Cl. G06F 17/00

(52) U.S. Cl. 715/507

(57) ABSTRACT

A Web-based client/server interaction method and system is proposed, which is designed for use with a server/client architecture on a network system for the purpose of allowing Web servers to gather user-supplied data from Web clients, and which is characterized by the use of a specially-designed set of customized tags which are labeled to user-supplied data items through customized forms displayed through Web pages on the Web client. When the server receives the tagged data file, it is parsed to extract the data items and the associated tags that indicate the database table and fields where the data items are to be stored, and then stores these data items accordingly into the database. This feature allows Web servers to gather data from Web clients and store the gathered data into a database more efficiently.

### BACKGROUND OF THE INVENTION

1. Field of the Invention

This invention relates to Web technology, and more particularly, to a Web-based client/server interaction method and system, which is designed for use with a server/client architecture on a network system, such as Internet, an intranet system, an extranet system, and so on, for the purpose of allowing Web servers to gather user-supplied data from Web clients and store the gathered data into a database with the help of a specially-designed markup tags, and for the purpose of allowing users at the Web clients to search required data through the network system.

2. Description of Related Art:

HTML Forms, one of the most important features of the World Wide Web, has remained relatively stagnant over the last eight years, despite many attempts to improve them. Most proposals to improve web forms, such as XFDL, XFA, FML and XForms have taken the approach of defining new markup languages to improve forms, although each has approached the problem from its own unique perspective. XFDL provides full security features and supports built-in logic, calculations, type checking, enclosures, and online help. These features make it suitable for government and business uses. XFA supports multiple views of the document and the data, absolute and relative positioning of form objects and data, and digital signatures that make it an appropriate intermediate format for forms in client applications. The design of FML is focused on improving web base interaction and is defined as an XHTML module. It is more “web-oriented” by design and is suitable for building web interfaces. Although these specifications are all open to public, their implementations are still proprietary and special viewers or servers are required. Currently, XForms is an official effort by W3C XForms Working Group to realize the vision of a “Next Generation Form”. XForms is designed to cover a broad range of issues including: purpose definition, data entry, event model, schema validation, and form submission. Since all of these features have been integrated into a single specification, XForms is inevitably a lot more complex than HTML itself, and XForms requires the XML Schema while editing XML based content, thus the forms have to be designed by experts at design time, and are less flexible. It is believed that simplicity is one of the key success factors of HTML. Therefore, there exists a need in the information industry for methodology that can be applied to standard HTML to build complex forms and collect XML data without modifying existing browsers and web servers.

### SUMMARY OF THE INVENTION

It is a primary objective of this invention to provide a Web-based client/server interaction method and system that is capable of allowing a Web server to gather user-supplied data from a Web client and store the gathered data into a server-side database in a more efficient manner than prior art.

It is another objective of this invention to provide a Web-based client/server interaction method and system, for allowing a form provider to design corresponding form content according to a required Web page, and which can analyze data inputted to the form and store the required data, and generate the modified form with respect to the generated data and the form layout on client side or server side, thereby providing functions of designing a form page and data management.

In accordance with the above and other objectives, the present invention proposes a Web-based client/server interaction method for use with a Web server linked via a network system to a Web client. The Web-based client/server interaction method comprises: in response to a URL from the Web client, activating the Web server to serve up a Web page via the network system to the Web client for the Web page to run on the Web client and thereby display an associated form on the Web client for user-operated data entry, with user-inputted data items being processed to generate a tagged data file in which the user-inputted data items are labeled with customized tags that represent a set of database storage attributes for the data items; processing each tagged data file returned from the Web client to the Web server to thereby extract the user-inputted data items and the associated tags representative of the database storage attributes thereof; and storing the data items extracted from the tagged data file into a database module in accordance with the database storage attributes of the extracted data items.

In another embodiment of the invention, the Web-based client/server interaction method comprises: establishing a form on the Web client for a user at the Web client to input data via the form page, wherein input boxes provided by the form each has a tag identification mark or has both tag and index identification marks; determining at the Web client the input boxes of the form being inputted with data items, and adding the identification marks corresponding to the input boxes to the inputted data items in the input boxes to form a tagged data file, such that the tagged data file is transferred to the Web server via the network system; upon receiving the tagged data file, processing the tagged data file transferred from the Web client to the Web server to thereby extract the user-inputted data items and the associated tags representative of a set of database storage attributes for the data items; and storing the data items extracted from the tagged data file into a database module in accordance with the database storage attributes of the extracted data items.

The present invention also proposes a Web-based client/server interaction system for use with a Web server linked via a network system to a Web client. The Web-based client/server interaction system comprises: a database module for storing user-supplied data items from the Web client; a server/client data exchange interface module for allowing the Web server to exchange data via the network system with the Web client; a form serving module for storing a collection of Web pages coded in a markup language and embedded with customized forms, which is capable of serving up each Web page by way of the server/client data exchange interface module and via the network system to the Web client for the Web page to run on the Web client and thereby display an associated form on the Web client for user-operated data entry, with user-inputted data items being processed to generate a tagged data file in which the user-inputted data items are labeled with customized tags that represent a set of database storage attributes for the data items and to rebuild the customized forms from a set of given tagged data; a tagged data file processing module for processing each tagged data file returned from the Web client to the Web server to thereby extract the user-inputted data items and the associated tags representative of the database storage attributes thereof; and a data storing module for storing the data items extracted from the tagged data file into the database module in accordance with the database storage attributes of the extracted data items.

When rebuilding the customized forms from the tagged data, the form serving module can utilize the web pages loaded in the module to reconstruct the hierarchical structure in accordance with the given tagged data.

In another embodiment of the invention, the Web-based client/server interaction system comprises: a database module; a form serving module for providing at least one form for a user at the Web client to input data via the form, wherein input boxes provided by the form each has a tag identification mark or has both tag and index identification marks, and the form serving module for determining the input boxes of the form being inputted with data items and adding the identification marks corresponding to the input boxes to the inputted data items in the input boxes to form a tagged data file, such that the tagged data file is transferred to the Web server via the network system; a server/client data exchange interface module for allowing the Web server to exchange data via the network system with the Web client; a tagged data file processing module for processing each tagged data file transferred to the Web server to thereby extract the user-inputted data items and the associated tags representative of a set of database storage attributes for the data items; and a data storing module for storing the data items extracted from the tagged data file into the database module in accordance with the database storage attributes of the extracted data items.

The Web-based client/server interaction method and system according to the invention are designed for use with a server/client architecture on a network system, such as Internet, an intranet system, an extranet system, and so on, for the purpose of allowing Web servers to gather user-supplied data from Web clients and store the gathered data into a database with the help of specially-designed markup tags.

The Web-based client/server interaction method and system according to the invention are characterized by the use of a specially-designed set of customized tags which are labeled to user-supplied data items through customized forms displayed through Web pages on the Web client. When the server receives the tagged data file, it is parsed to extract the data items and the associated tags that indicate the database table and fields where the data items are to be stored, and then stores these data items accordingly into the database. This feature allows Web servers to gather data from Web clients and store the gathered data into a database more efficiently.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and modularized object-oriented component model of the Web-based client/server interaction system according to the invention;

FIG. 2 is a schematic diagram showing an example of a data entry form and its HTML/XML code utilized by the Web-based client/server interaction system of the invention;

FIG. 3 is a schematic diagram showing the same data entry form of FIG. 2 when data are filled into the data entry form and a tagged data file generated from the data entry form;

FIG. 4 is a schematic diagram showing an example of a fragment of data assertion code and an associated message box utilized by the Web-based client/server interaction system of the invention;

FIG. 5 is a schematic diagram showing an example of a database table used to store the data items received by the data entry form shown in FIG. 3;

FIGS. 6(A) and 6(B) are schematic diagrams showing another example of data content architecture after data storage is performed by the Web-based client/server interaction method and system according to the invention; and

FIG. 7 is a schematic diagram showing the Web-based client/server interaction system according to another embodiment of the invention.

### DETAILED DESCRIPTION OF PREFERRED EMBODIMENTS

The Web-based client/server interaction method and system according to the invention are disclosed in full details by way of preferred embodiments in the following with reference to the accompanying drawings.

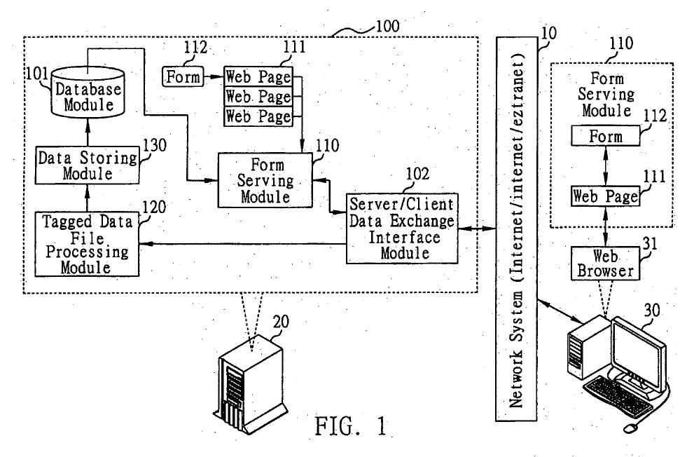

FIG. 1 is a schematic diagram showing the application architecture and modularized object-oriented component model of the Web-based client/server interaction system according to the invention (as the part enclosed in the dotted box indicated by the reference numeral 100). As shown, the Web-based client/server interaction system 100 of the invention is designed for use with a server/client architecture on a network system 10, particularly a Web-oriented network system, such as Internet, an intranet system, an extranet system, and so on, where the server/client architecture includes a Web server 20 which is linkable via the network system 10 to one or more Web clients 30 (in FIG. 1, only one Web client is illustrated for demonstration). Moreover, the Web client 30 should be installed with a Web browser 31, such as Microsoft Internet Explorer or NetScape Navigator.

Functionally, the Web-based client/server interaction system 100 of the invention is capable of serving up Web pages 111 coded in a standard markup language, such as HTML (HyperText Markup Language) or XML (eXtensible Markup Language), from the Web server 20 via the network system 10 to the Web client 30, with the Web pages 11 embedded with one or more forms 112 for the user at the Web client 30 to enter data, such as personal data, transaction data, registration data, to name a few, and the Web-based client/server interaction system 100 of the invention will automatically receive and store the user-supplied data into a server-side database, such as a relational database.

The modularized object-oriented component model of the Web-based client/server interaction system 100 of the invention is shown in FIG. 1. As shown, the Web-based client/server interaction system 100 of the invention comprises: (a) a database module 101; (b) a server/client data exchange interface module 102; (c) a form serving module 110; (d) a tagged data file processing module 120; and (e) a data storing module 130.

The server/client data exchange interface module 102 is for example based on the standard HTTP (HyperText Transport Protocol) and is linked to the network system 10 to allow the Web server 20 to exchange data via the network system 10 with the Web client 30, i.e., allow the Web server 20 to send HTML/XML-coded Web pages 11 over the network system 10 to the Web client 30 and receive responses from the Web client 30.

The form serving module 110 comprises for example an agent program. When the Web client 30 is linked to the Web server 20 via the network system 10, the form serving module 110 can be downloaded to communicate with the server/client data exchange interface module 102 through the downloaded form serving module 110. The server/client data exchange interface module 102 of the Web server 20 provides a download processing mechanism.

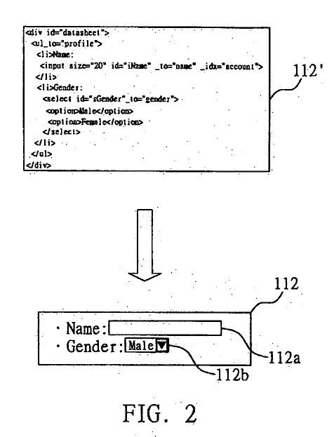

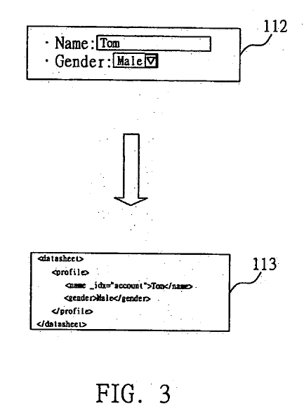

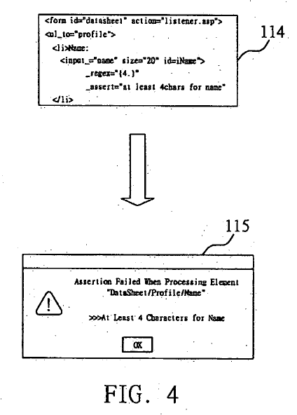

The form serving module 110 is used to store a collection of Web pages that are coded in a standard markup language, such as HTML or XML, and embedded with HTML/XML code that represents customized forms in accordance with the invention, and the form serving module 110 is capable of downloading a client-requested Web page 11 via the server/client data exchange interface module 102 and the network system 10 to the Web client 30. When a Web page 11 is downloaded to the Web client 30, it can display a form 112 on the Web client 30 through the Web browser 31 for the user to input data, such as personal data, transaction data, registration data, to name a few. In other words, after the form serving module 110 is downloaded to the Web client 30 provided with the Web browser 31, the Web client 30 can obtain the Web page 11 provided by the Web server 20 through the downloaded form serving module 110 and also the form 112 provided by the Web page 111. In this embodiment, for example, the form 112 is provided for the user at the Web client 30 to input data. FIG. 2 shows an example of a segment of HTML/XML code 112′ that is used to generate a form 112, such as a data entry form, which includes a text input box 112a and a combo box 112b for the user to input data about his/her name and gender respectively. In the example of FIG. 3, the user inputs “Tom” into the text input box 112a and select “Male” from the combo box 112b. As the data input is completed, a script in the Web page 11 then labels the user-supplied data items with customized tags that represent a set of database storage attributes for these user-supplied data items to thereby generate a tagged data file 113 as illustrated in FIG. 3. In the example of FIG. 3, the user-supplied data item “Tom” is enclosed within the tags <name> and </name> to indicate that this data item is to be stored in the field “Name” in the database module 101; whereas the data item “Male” is enclosed within the tags <gender> and </gender> to indicate that this data item is to be stored in the field “Gender” in the database module 101. Moreover, after the user inputs the name data into the text input box 112a of the form 112, the form serving module 110 establishes an index on the name data inputted into the text input box 112a, for example, the index is named “account” in this embodiment, and the index can serve as reference for the database module 101 to recognize and search the name data. The tagged data file 113 is then transferred by the Web browser 31 via the network system 10 back to the Web server 20 where the tagged data file 113 is received by the server/client data exchange interface module 102 and transferred to the tagged data file processing module 120. In addition, as shown in FIG. 4, the markup script in the Web page 111 can further optionally include a fragment of data assertion code 114 for providing a data assertion function on the user-inputted data. In the example of FIG. 4, the data assertion code 114 is used to check whether the string of the inputted name is at least 4 characters in length; if NOT, a message box 115 is displayed to inform the user of the error condition. Beside length, other data assertion criteria can be utilized to restrict the attributes of the user-inputted data items.

The tagged data file processing module 120 is capable of processing each tagged data file 113 received by the Web server 20 from the Web client 30 by parsing the contents of the tagged data file 113 to extract each user-inputted data item and the associated tags representative of the database storage attributes thereof. The extracted data items and their database storage attributes are then sent to the data storing module 130. With the tagged data file 113 shown in FIG. 3, for example, the tagged data file processing module 120 extracts two data items “Tom” and “Male” and their respective tags indicating that the first data item “Tom” belongs to the field “Name” in the database module 101 and the second data item “Male” belongs to the field “Gender”.

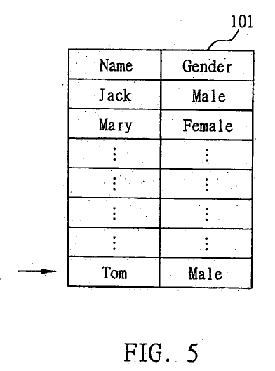

The data storing module 130 is capable of storing each data item extracted from the tagged data file 113 into the database module 101 in accordance with the database storage attributes of each data item. With the tagged data file 113 shown in FIG. 3, for example, the data storing module 130 stores the first data item “Tom” into the field “Name” in the database module 101 and the second data item “Male” into the field “Gender” in the same database module 101, as illustrated in FIG. 5.

Referring to FIG. 1 together with FIG. 2 through FIG. 5, in actual operation, when the user at the Web client 30 wants to view a Web page and send data to the Web server 20, the user needs just to utilize the Web browser 31 on the Web client 30 to issue a URL (Uniform Resource Locator) of the desired Web page via the network system 10 to the Web server 20. When the Web server 20 receives the URL, the HTTP-compliant server/client data exchange interface module 102 will forward the received URL to the form serving module 110. In response, the form serving module 110 retrieves the user-requested Web page 111 and then downloads it by way of the HTTP server/client data exchange interface module 102 and via the network system 10 to the Web client 30 where the downloaded Web page 11 together with its embedded form 112 will be displayed through the Web browser 31 on the Web client 30. An example of the displayed form 112 is shown in FIG. 2, which requests the user to input two items of data about the user's identity: name and gender. In this example, it is assumed that the user is a male named Tom, so that as shown in FIG. 3 the user needs to input “Tom” to the text input box 112a and select “Male” from the combo box 112b in the form 112. As the data input is completed, a script in the Web page 11 will process the user-supplied data in such a manner as to generate a tagged data file 113 in which each user-inputted data item is labeled with customized tags that represent a set of database storage attributes for the associated data item as illustrated in FIG. 3. In the example of FIG. 3, the user-supplied data item “Tom” is enclosed within the tags <name> and </name> to indicate that this data item is to be stored in the field “Name” of a table in the database module 101; whereas the data item “Male” is enclosed within the tags <gender> and </gender> to indicate that this data item is to be stored in the field “Gender” of the same table in the database module 101. The tagged data file 113 is then transferred by the Web browser 31 via the network system 10 back to the Web server 20 where the tagged data file 113 is received by the HTTP server/client data exchange interface module 102 and forwarded to the tagged data file processing module 120.

In response, the tagged data file processing module 120 processes the received tagged data file 113 by parsing the contents of the tagged data file 113 to extract each user-inputted data item and the associated tags representative of the database storage attributes thereof. With the tagged data file 113 shown in FIG. 3, the tagged data file processing module 120 will extract two data items “Tom” and “Male” and their respective tags that indicate that the first data item “Tom” belongs to the field “Name” in the database module 101 and the second data item “Male” belongs to the field “Gender”. These two data items “Tom” and “Male” together with their database storage attributes are then sent to the data storing module 130. In response, the data storing module 130 stores the first data item “Tom” into the field “Name” in the database module 101 and the second data item “Male” into the field “Gender” in the same database module 101, as illustrated in FIG. 5.

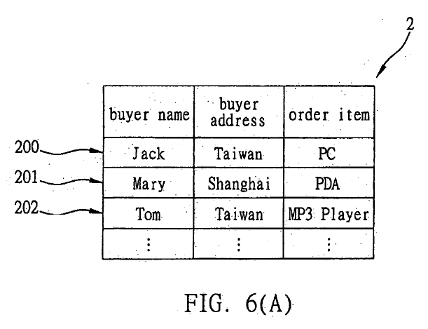

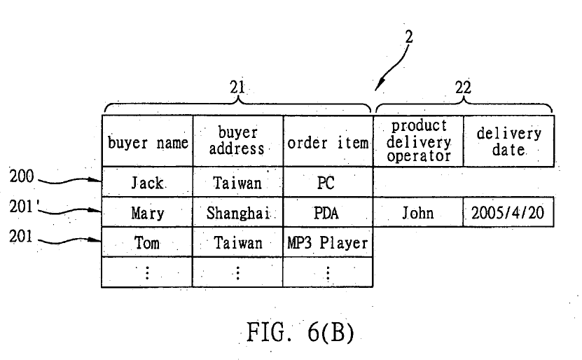

Moreover, in another embodiment of the Web-based client/server interaction system 100 of the invention, the form serving module 110 reads data items stored in the database module 101 to generate a new form for the user at the Web client 30 to edit or add/delete data. For example, when the invention is applied to an electronic purchase system (not shown), a buyer at the Web client 30 can obtain a basic data entry form from the form serving module 110 via the Web browser 31 and input basic data. The basic data entry form includes input boxes such as buyer name, buyer address, order item, and so on. The form is also coded by HTML/XML shown in FIG. 2, and data inputted to the input boxes such as buyer name, buyer address and order item are labeled with tags. Similarly, after the Web server 20 receives the data inputted from the Web client 30, the tagged data are stored in the database module 101. As shown in FIG. 6(A), the stored data 2 include a plurality of data records 200, 201, 202, each data record comprising a buyer name field, a buyer address field and an order item field. It should be noted that, the fields are not pre-established in the database module 101, but they are built by the tagged data file processing module 120 according to the tagged data, wherein in case the same tag is provided for certain data in the plurality of data records, the same field can be built to store the data labeled with the same tag.

Then, if a supplier at the Web client 30 wants to supply and deliver products according to the requirement of the buyer, the supplier can obtain information of products ordered by the buyer and perform product delivery via the Web-based client/server interaction system 100 of the invention. In particular, when the Web-based client/server interaction system 100 realizes a product delivery process to be performed by the supplier at the Web client 30, similarly, the supplier at the Web client 30 can obtain a product delivery input form (not shown) from the form serving module 110 and input product delivery data. The product delivery input form includes order details such as data of buyer name, buyer address and order item that are retrieved by the form serving module 110 from the database module 101 (the data access technology is conventional in the art and not to be further detailed here), for a product delivery operator to realize basic data of the products to be delivered. The product delivery input form also includes input boxes such as product delivery operator, delivery date and so on. The form is also coded by HTML/XML shown in FIG. 2, and data inputted to the input boxes such as delivery operator and delivery date are labeled with tags. Similarly, after the Web server 20 receives the data inputted from the Web client 30, the tagged data are stored in the database module 101. As shown in FIG. 6(B), the stored data 2′ includes two parts; the first part 21 is established by the buyer, and the second part 22 is established by the supplier. Since currently the supplier has only completed one record of product delivery, only the data record 201′ is provided with a product delivery operator field and a delivery date field. Similarly, it should be noted that the fields are not pre-established in the database module 101, but they are built by the tagged data file processing module 120 according to the tagged data. The tagged data gathered can be nested with arbitary levels of hierarchy.

Besides in the foregoing embodiments the data entry form being provided by the Web-based client/server interaction method and system of the invention, a search function can also be achieved in the invention by the form serving module 110 to read the data stored in the database module 101 and generate a search form. For example, the Web page 11 provided from the Web server 20 through the network system 10 to the Web client 30 further comprises a search form (not shown) for the user at the Web client 30 to input search data. The search form comprises an input box for the user at the Web client 30 to input the search data, and the input box corresponds to a tag. When the Web page 11 determines that there are search data inputted to the input box, it retrieves a tag from the database module 101 identical to the corresponding tag for the input box and obtains data items corresponding to the retrieved tag to verify the obtained data items complying with the search data inputted to the input box, such that the Web server 20 displays the search result in the form of Web page on the Web client 30 through the network system 10.

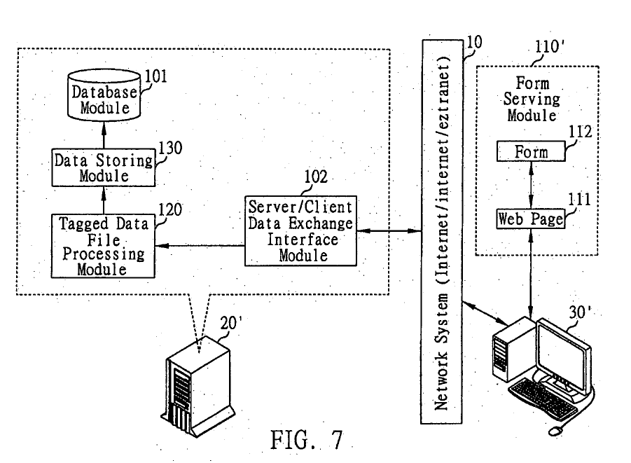

Apart from in the foregoing embodiment that the Web client 30 is linked to the Web server 20 via the network system 10 to download the form 112 provided by the form serving module 110, a Web client 30′ can alternatively be in advance installed or downloaded online with a form serving module 110′ that is used to provide various forms 112 for data input/output as shown in the Web-based client/server interaction system of FIG. 7 according to another embodiment of the invention. It should be noted that for the sake of simplicity, the Web server 20′ in this embodiment same as the Web server 20 shown in FIG. 1 is not to be further detailed in its operation relationship; only the differences between this embodiment and the foregoing embodiment shown in FIG. 1 are discussed.

The Web client 30′ is pre-installed with the form serving module 110′. In response to the user's requirement, the form serving module 110′ would provide a corresponding form such as a search form or a data editing form (the data editing form can perform data addition, deletion and/or amendment, etc.), wherein each input box provided by the form has a tag identification mark, or has both tag and index identification marks such as an (the index serves as reference for the database to recognize data corresponding to the input/output box for the search purpose). Therefore, as the displayed content of the form is coded by the standard markup language such as HTML or XML, after the user inputs the required data to the form, the form serving module 110′ allows the form with the inputted data to form a tagged data file and transfers the tagged data file via the network system 10 to the Web server 20′ where the tagged data file would be processed. It should be noted that in this embodiment, besides by a conventional uploading technique, the form with the inputted data can also be transferred from the Web client 30′ to the Web server 20′ by a general e-mailing technique. The Web server 20′ receiving the form processes the tagged data file transferred from the Web client 30′ by using a processing method similar to that described in the embodiment shown in FIG. 1; thus, the processes such as analyzing and storage performed on the tagged data file are not repeatedly described here for the sake of simplicity.

Therefore, from FIG. 7, in addition to establishing and maintaining data for the user at the Web client through the use of the Web-based client/server interaction method and system of the invention, the form provider can also provide a corresponding form page in response to the user's requirement, and different form pages have identification marks such as tags or indexes, which can be recognized by the database module and also be used for data maintenance of the database module.

Apart from the system architecture shown in FIGS. 1 and 7, the database module 101 may alternatively be independently provided outside the Web server 20, 20′; in other words, the Web-based client/server interaction system of the invention encompasses different integrated structures between the modules thereof according to the requirements in practical implementation. And parts of the tagged forms can be located in different servers and used by the web client to construct the user interface on the Form Serving Module.

In conclusion, the invention provides a Web-based client/server interaction method and system for use with a server/client architecture on a network system for the purpose of allowing Web servers to gather user-supplied data from Web clients via the network system, and which is characterized by the use of a specially-designed set of customized tags which are labeled to user-supplied data items through customized forms displayed through Web pages on the Web client. When the server receives the tagged data file, it is parsed to extract the data items and the associated tags that indicate the database table and fields where the data items are to be stored, and then stores these data items accordingly into the database. This feature allows Web servers to gather data from Web clients and store the gathered data into a database more efficiently.

Moreover, the Web-based client/server interaction method and system of the invention utilize the tagged data in the parse program (HTML or XML) to allow the system to recognize whether the tagged data comprise inputted data (such as data in the text input box) or stored data (such as data in the fields), and process the stored data corresponding to the recognized tags so as to store valid data. Therefore, there is no need to pre-establish a data table in the database, and associated fields or data records can be automatically increased in response to practical design requirements. This allows different data records to have different data fields if necessary, thereby making the design more conveniently implemented and not restricted to the fixed form of data table in the conventional database.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A Web-based client/server interaction method for use with a Web server linked via a network system to a Web client;
the Web-based client/server interaction method comprising:
in response to a URL from the Web client, activating the Web server to serve up a Web page via the network system to the Web client for the Web page to run on the Web client and thereby display an associated form on the Web client for user-operated data entry, with user-inputted data items being processed to generate a tagged data file in which the user-inputted data items are labeled with customized tags that represent a set of database storage attributes for the data items;
processing each tagged data file returned from the Web client to the Web server to thereby extract the user-inputted data items and the associated tags representative of the database storage attributes thereof;
storing the data items extracted from the tagged data file into a database module in accordance with the database storage attributes of the extracted data items.

2. The Web-based client/server interaction method of claim 1, wherein the Web page is coded in a markup language of HTML (Hypertext Markup Language) or XML (eXtensible Markup Language).

3. The Web-based client/server interaction method of claim 1, wherein the user-inputted data item labeled with the tag has an index for being recognized and searched by the database module.

4. The Web-based client/server interaction method of claim 1, wherein the Web page further includes a data assertion function on the user-inputted data to check whether the user-inputted data complies with predefined criteria.

5. The Web-based client/server interaction method of claim 1, wherein after providing the URL and being linked to the Web server, the Web client performs a downloading process of a service procedure such that the Web page for providing the form is downloaded from the Web server to the Web client to process the form.

6. The Web-based client/server interaction method of claim 1, wherein the form provided by the Web server to the Web client via the network system further comprises a search form for the Web client to input search data, the search form comprising an input box for the Web client to input the search data, and the input box corresponding to a tag, such that when the search data are inputted to the input box by the Web client and are transferred in the form of tagged data file to the Web server, the Web server retrieves a tag from the database module identical to the corresponding tag for the input box in the tagged data file and obtains data items corresponding to the retrieved tag so as to verify the obtained data items complying with the search data inputted to the input box and display search result in the form of Web page on the Web client via the network system.

7. A Web-based client/server interaction system for use with a Web server linked via a network system to a Web client;
the Web-based client/server interaction system comprising:
a database module for storing user-supplied data items from the Web client;
a server/client data exchange interface module for allowing the Web server to exchange data via the network system with the Web client;
a form serving module for storing a collection of Web pages coded in a markup language and embedded with customized forms, and which is capable of serving up each Web page by way of the server/client data exchange interface module and via the network system to the Web client for the Web page to run on the Web client and thereby display an associated form on the Web client for user-operated data entry, with user-inputted data items being processed to generate a tagged data file in which the user-inputted data items are labeled with customized tags that represent a set of database storage attributes for the data items;
a tagged data file processing module for processing each tagged data file returned from the Web client to the Web server to thereby extract the user-inputted data items and the associated tags representative of the database storage attributes thereof;
a data storing module for storing the data items extracted from the tagged data file into the database module in accordance with the database storage attributes of the extracted data items; and
a form reconstruction module for reconstructing the forms from the extracted tagged data files and the Web pages loaded in the form serving module.

8. The Web-based client/server interaction system of claim 7, wherein the Web page markup language is HTML (HyperText Markup Language) or XML (eXtensible Markup Language).

9. The Web-based client/server interaction system of claim 7, wherein the Web page further includes a data assertion function on the user-inputted data to check whether the user-inputted data complies with predefined criteria.

10. The Web-based client/server interaction system of claim 7, wherein the user-inputted data item labeled with the tag has an index for being recognized and searched by the database module.

11. The Web-based client/server interaction system of claim 7, wherein when the Web client is linked to the Web server via the network system, the server/client data exchange interface module is allowed to download the form serving module to the Web client, such that the Web client obtains the Web page provided by the Web server via the form serving module.

12. The Web-based client/server interaction system of claim 7, wherein the Web page provided via the form serving module to the Web client further comprises a search form for the Web client to input search data, the search form comprising an input box for the Web client to input the search data, and the input box corresponding to a tag, such that when the search data are inputted to the input box by the Web client and are transferred in the form of tagged data file to the Web server, the server/client data exchange interface module transfers the received tagged data file to the tagged data file processing module, and the tagged data file processing module retrieves a tag from the database module identical to the corresponding tag for the input box in the tagged data file and obtains data items corresponding to the retrieved tag to verify the obtained data items complying with the search data inputted to the input box, such that search result is displayed by the Web server in the form of Web page on the Web client via the network system.

13. A Web-based client/server interaction method for use with a Web server linked via a network system to a Web client;
the Web-based client/server interaction method comprising:
establishing a form on the Web client for a user at the Web client to input data via the form page, wherein input boxes provided by the form each has a tag identification mark or has both tag and index identification marks;
reconstructing the form with respect to the tagged data file and the Web pages;
determining at the Web client the input boxes of the form being inputted with data items, and adding the identification marks corresponding to the input boxes to the inputted data items in the input boxes to form a tagged data file, such that the tagged data file is transferred to the Web server via the network system;
upon receiving the tagged data file, processing the tagged data file transferred from the Web client to the Web server to thereby extract the user-inputted data items and the associated tags representative of a set of database storage attributes for the data items; and
storing the data items extracted from the tagged data file into a database module in accordance with the database storage attributes of the extracted data items.

14. The Web-based client/server interaction method of claim 13, wherein the form is coded in a markup language of HTML (Hypertext Markup Language), XML (eXtensible Markup Language) based markup languages.

15. The Web-based client/server interaction method of claim 13, wherein the tag and index identification marks are for being recognized and searched by the database module.

16. The Web-based client/server interaction method of claim 13, wherein the Web client retrieve the data items stored in the database module and the Web pages stored in the Web server via network system and generates a processing form according to the information as a Web page, the processing form comprising the data items read from the database module and an input box for the Web client to input data, and the data items and the input box corresponding to tags respectively, such that when the data are inputted to the input box by the Web client and are transferred in the form of tagged data file to the Web server, the Web server extracts the tag corresponding to the input box in the tagged data file, the data inputted to the input box, the data items and the tags corresponding to the data items to form a data record.

17. A Web-based client/server interaction system for use with a Web server linked via a network system to a Web client;
the Web-based client/server interaction system comprising:
a database module;
a form serving module for providing at least one form for a user at the Web client to input data via the form, wherein input boxes provided by the form each has a tag identification mark or has both tag and index identification marks, and the form serving module for determining the input boxes of the form being inputted with data items and adding the identification marks corresponding to the input boxes to the inputted data items in the input boxes to form a tagged data file, such that the tagged data file is transferred to the Web server via the network system;
a server/client data exchange interface module for allowing the Web server to exchange data via the network system with the Web client;
a tagged data file processing module for processing each tagged data file transferred to the Web server to thereby extract the user-inputted data items and the associated tags representative of a set of database storage attributes for the data items; and
a data storing module for storing the data items extracted from the tagged data file into the database module in accordance with the database storage attributes of the extracted data items.

18. The Web-based client/server interaction system of claim 17, wherein the form is coded in a markup language of HTML (HyperText Markup Language) or XML (eXtensible Markup Language).

19. The Web-based client/server interaction system of claim 17, wherein the tag and index identification marks are for being recognized and searched by the database module.

20. The Web-based client/server interaction system of claim 17, wherein the form serving module further reads the data items stored in the database module via the network system to generate a processing form and provides the processing form as a Web page, the processing form comprising the data items read from the database module and an input box for the Web client to input data, and the data items and the input box corresponding to tags respectively, such that when the data are inputted to the input box by the Web client and are transferred in the form of tagged data file to the Web server, the server/client data exchange interface module transfers the received tagged data file to the tagged data file processing module, and the tagged data file processing module extracts the tag corresponding to the input box in the tagged data file, the data inputted to the input box, the data items and the tags corresponding to the data items to allow the data storing module to store the extracted data from the tagged data file processing module to the database module.
